(19) United States
(12) Patent Application Publication
(10) Pub. No.: US 2024/0044370 A1
(43) Pub. Date: Feb. 8, 2024

(54) Rolling Bearing

(71) Applicant: NIPPON THOMPSON CO., LTD., Tokyo (JP)

(72) Inventor: Kenichiro TSURUTA, Mino-shi, Gifu (JP)

(21) Appl. No.: 17/904,233

(22) PCT Filed: Sep. 17, 2021
(86) PCT No.: PCT/JP2021/034372

§ 371 Date: Sep. 26, 2023

(30) Foreign Application Priority Data
Sep. 25, 2020 (JP) 2020-161341

(51) Int. Cl. F16C 33/60; F16C 19/36

(52) U.S. Cl. CPC F16C 33/60; F16C 19/36

(57) ABSTRACT

A rolling bearing includes a steel outer ring, a steel inner ring having a common central axis with the outer ring and disposed on an inner circumference side of the outer ring, and a plurality of rolling elements disposed to be able to roll on an inner circumferential surface of the outer ring and an outer circumferential surface of the inner ring. The outer ring includes a first outer ring and a second outer ring that is arranged alongside the first outer ring in a first axis direction in which the central axis extends and is fixed to the first outer ring. The inner ring includes a first inner ring and a second inner ring that is arranged alongside the first inner ring in the first axis direction and is fixed to the first inner ring. The outer ring has a protruding portion and a through hole corresponding to the protruding portion formed in one and the other of opposing portions in the first and second outer rings, the protruding portion and the through hole being fitted together. The inner ring has a protruding portion and a through hole corresponding to the protruding portion formed in one and the other of opposing portions in the first and second inner rings, the protruding portion and the through hole being fitted together. A slit is provided around either one or both of the protruding portion and the through hole.

### TECHNICAL FIELD

The present invention relates to a rolling bearing. The present application claims priority based on Japanese Patent Application No. 2020-161341 filed on Sep. 25, 2020, the entire contents of which are incorporated herein by reference.

### BACKGROUND ART

A rolling bearing having an outer ring and an inner ring each composed of a pair of plate members is known (see, e.g., Patent Literature 1).

### CITATION LIST

### Patent Literature

Patent Literature 1: Japanese Patent Application Laid-Open No. 2019-178735

### SUMMARY OF INVENTION

### Technical Problem

It is preferable that a rolling bearing can be produced in a rational and stable manner. Therefore, one of the objects is to provide a rolling bearing with excellent efficiency and stability in its production.

### Solution to Problem

A rolling bearing according to the present disclosure includes: an outer ring made of steel; an inner ring made of steel, having a common central axis with the outer ring and arranged on an inner circumference side of the outer ring; and a plurality of rolling elements disposed to be able to roll on an inner circumferential surface of the outer ring and an outer circumferential surface of the inner ring. The outer ring includes a first outer ring and a second outer ring arranged alongside the first outer ring in a first axis direction in which the central axis extends, the second outer ring being fixed to the first outer ring. The inner ring includes a first inner ring and a second inner ring arranged alongside the first inner ring in the first axis direction, the second inner ring being fixed to the first inner ring. The outer ring has a protruding portion and a through hole corresponding to the protruding portion formed in one and the other of opposing portions in the first and second outer rings, the protruding portion and the through hole being fitted together. The inner ring has a protruding portion and a through hole corresponding to the protruding portion formed in one and the other of opposing portions in the first and second inner rings, the protruding portion and the through hole being fitted together. A slit is provided around either one or both of the protruding portion and the through hole.

### Advantageous Effects of Invention

According to the rolling bearing described above, a rolling bearing with excellent efficiency and stability in its production can be provided.

### BRIEF DESCRIPTION OF DRAWINGS

FIG. 1 is a schematic perspective view showing the structure of a rolling bearing in Embodiment 1;

FIG. 2A is a schematic perspective view showing the structure of an outer ring of the rolling bearing in Embodiment 1;

FIG. 2B is a schematic perspective view showing the structure of the outer ring of the rolling bearing in Embodiment 1;

FIG. 3A is a schematic perspective view showing the structure of an inner ring of the rolling bearing in Embodiment 1;

FIG. 3B is a schematic perspective view showing the structure of the inner ring of the rolling bearing in Embodiment 1;

FIG. 4 is a schematic perspective view of Embodiment 1, with a first outer ring and a first inner ring removed therefrom;

FIG. 5 is a schematic cross-sectional view showing the structure of the rolling bearing in Embodiment 1;

FIG. 6 is a schematic cross-sectional view showing the structure of the rolling bearing in Embodiment 1;

FIG. 7 is a schematic diagram showing the states of grain flows in the outer and inner rings;

FIG. 8 is a schematic cross-sectional view showing the structure of the rolling bearing in Embodiment 1;

FIG. 9 is a schematic cross-sectional view showing the structure of the rolling bearing in Embodiment 1;

FIG. 10 is a schematic plan view showing a variation in Embodiment 1;

FIG. 11 is a schematic perspective view showing the structure of a rolling bearing in Embodiment 2;

FIG. 12 is a schematic perspective view of Embodiment 2, with a first outer ring and a first inner ring removed therefrom; and

FIG. 13 is an enlarged schematic perspective view of a portion of the schematic perspective view in FIG. 12, with a second inner ring removed and some of rolling elements omitted.

### DESCRIPTION OF EMBODIMENTS

### Outline of Embodiments

First, embodiments of the present disclosure will be listed and described. A rolling bearing of the present disclosure includes: an outer ring made of steel; an inner ring made of steel, having a common central axis with the outer ring and arranged on an inner circumference side of the outer ring; and a plurality of rolling elements disposed to be able to roll on an inner circumferential surface of the outer ring and an outer circumferential surface of the inner ring. The outer ring includes a first outer ring and a second outer ring arranged alongside the first outer ring in a first axis direction in which the central axis extends, the second outer ring being fixed to the first outer ring. The inner ring includes a first inner ring and a second inner ring arranged alongside the first inner ring in the first axis direction, the second inner ring being fixed to the first inner ring. The outer ring has a protruding portion and a through hole corresponding to the protruding portion formed in one and the other of opposing portions in the first and second outer rings, the protruding portion and the through hole being fitted together. The inner ring has a protruding portion and a through hole corresponding to the protruding portion formed in one and the other of opposing portions in the first and second inner rings, the protruding portion and the through hole being fitted together. A slit is provided around either one or both of the protruding portion and the through hole.

Conventionally, a rolling bearing as disclosed in Patent Literature 1, for example, is known. In the rolling bearing disclosed in Patent Literature 1, the outer ring and the inner ring constituting the rolling bearing are each made up of a pair of members divided in the axial direction (referred to as a pair of split rings of an outer ring and a pair of split rings of an inner ring). In the rolling bearing in Patent Literature 1, the pair of split rings of the outer ring and the pair of split rings of the inner ring are formed into predetermined shapes by press working or the like, and then a projection and a recess formed in one and the other of each pair of members are fitted together, whereby the split rings are fixed to each other. However, there is a risk of some misalignment occurring between a projection and a recess during the press working or other process steps.

If the positions of the projection and the recess are significantly different, the projection and the recess cannot be fitted together, hindering the assembly of the outer and inner rings. On the other hand, if the misalignment between the projection and the recess is small, the projection and the recess can be fitted together to produce a rolling bearing. However, depending on the size of such a misalignment, distortion at the fitting portion caused by the misalignment may affect the performance of the rolling bearing. Specifically, the misalignment at the fitting portion may cause a reduction in the roundness of the outer and inner rings, and radial and axial runout may increase.

Producing high-precision components may be a countermeasure to eliminate the misalignment between a projection and a recess. However, this may not always be a rational approach because producing high-precision components leads to higher production costs. According to the rolling bearing of the present disclosure, the slits provided around the protruding portion and the through hole are able to absorb the distortion caused by the misalignment therebetween in the vicinity of the protruding portion and the through hole, whereby the overall roundness of the outer and inner rings can be maintained. With such a configuration, a rolling bearing that ensures both efficiency and stability in its production can be provided.

In the above rolling bearing, a plurality of such slits may be provided around the protruding portion or the through hole. Various possible manners of misalignment between a protruding portion and a through hole include misalignment of the protruding portion and the through hole in the circumferential direction, misalignment in the radial direction, and a combination thereof. Providing a plurality of slits makes it possible to absorb the misalignment irrespective of the manner of misalignment. Further, the rolling bearing can be made more symmetrical, which can suppress the occurrence of radial and axial runout.

In the above rolling bearing, the slit may be provided around the protruding portion. Such a configuration can suppress the reduction in rigidity of the outer ring and the inner ring due to the provision of the slit, while maintaining the effect of absorbing the misalignment with the slit.

In the above rolling bearing, a fitting portion between the protruding portion and the through hole may be bonded. Such a configuration ensures more secure fixation of the outer ring and the inner ring, and can also reduce the influence of the misalignment.

In the above rolling bearing, the first outer ring has an annular first rolling surface constituting the inner circumferential surface of the outer ring. The second outer ring has an annular second rolling surface constituting the inner circumferential surface of the outer ring. The first inner ring has an annular third rolling surface constituting the outer circumferential surface of the inner ring and opposing the second rolling surface. The second inner ring has an annular fourth rolling surface constituting the outer circumferential surface of the inner ring and opposing the first rolling surface. In a cross section including a central axis of the first rolling surface, a line segment connecting the first rolling surface and the fourth rolling surface intersects a line segment connecting the second rolling surface and the third rolling surface. In a cross section including the central axis of the rolling bearing, grain flows in the steel constituting the first outer ring may extend along the first rolling surface. Grain flows in the steel constituting the second outer ring may extend along the second rolling surface. Grain flows in the steel constituting the first inner ring may extend along the third rolling surface. Grain flows in the steel constituting the second inner ring may extend along the fourth rolling surface. This configuration can suppress contact of the rolling elements to the ends of the steel grain flows. Accordingly, the durability of the inner and outer rings can be improved. In addition to absorbing the misalignment between the protruding portion and the through hole with the above-described configuration, with the grain flows in the steels constituting the inner and outer rings being configured as described above, a rolling bearing with excellent durability can be obtained.

### Specific Embodiments

Specific embodiments of the rolling bearing of the present disclosure will be described below with reference to the drawings. In the drawings referenced below, the same or corresponding portions are denoted by the same reference numerals and the description thereof will not be repeated.

### Embodiment 1

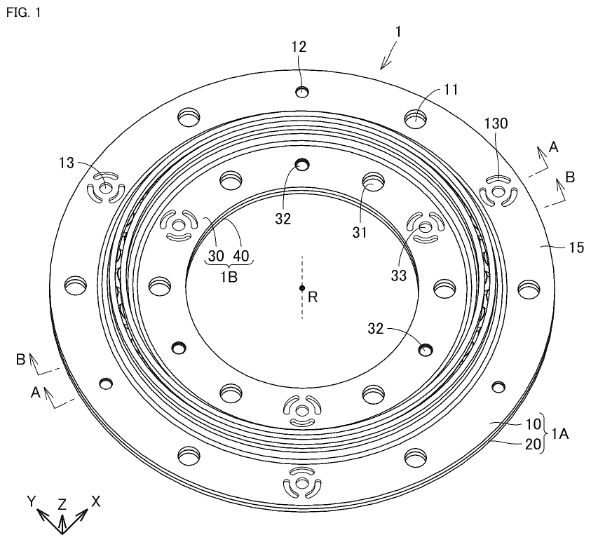

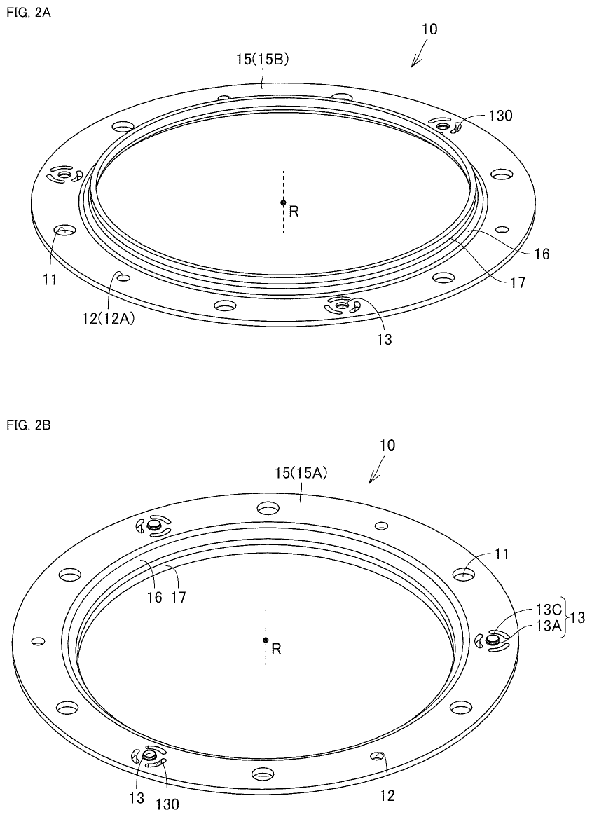

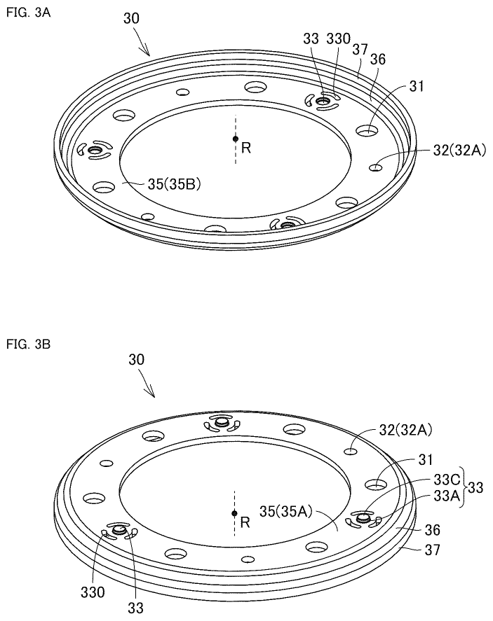

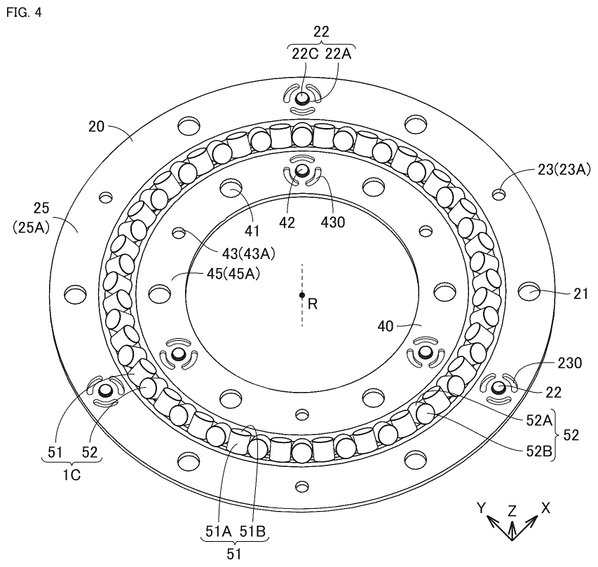

FIG. 1 is a schematic perspective view showing the structure of a rolling bearing in an embodiment (Embodiment 1) of the present disclosure. FIGS. 2A and 2B are schematic perspective views of an outer ring constituting the rolling bearing in Embodiment 1. FIGS. 3A and 3B are schematic perspective views of an inner ring constituting the rolling bearing in Embodiment 1. FIG. 4 is a schematic perspective view of the rolling bearing in Embodiment 1, with the outer and inner rings partially removed therefrom. The Z axis direction in FIG. 1 is a direction along a first axis direction in which a central axis R of the rolling bearing extends. The Z axis direction is a thickness direction of the rolling bearing. In contrast, the X-Y plane in FIG. 1 is a plane that extends in a radial direction of the rolling bearing.

Referring to FIGS. 1 to 4, the rolling bearing 1 in Embodiment 1 includes an outer ring 1A, an inner ring 1B, and a plurality of rollers 1C as rolling elements. The outer ring 1A and the inner ring 1B have a common central axis R. The outer ring 1A and the inner ring 1B are made of steel. The inner ring 1B is arranged on an inner circumference side of the outer ring 1A. In Embodiment 1, the outer ring 1A and the inner ring 1B are made of steel plates that have been worked into a predetermined shape. In Embodiment 1, the steel that constitutes the outer ring 1A and the inner ring 1B is, for example, SCM415 as specified in the JIS standard.

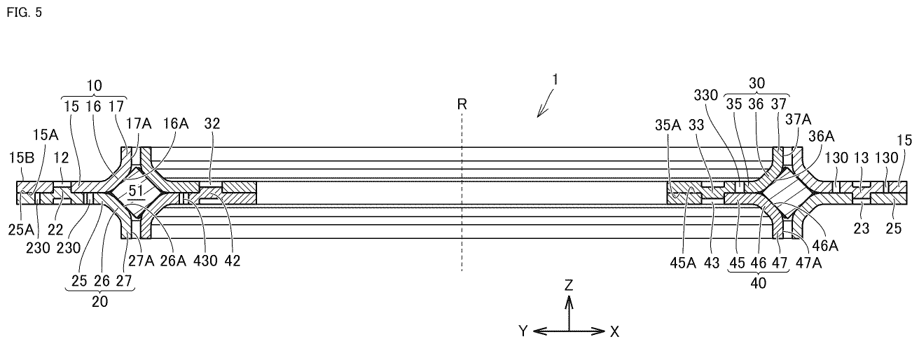

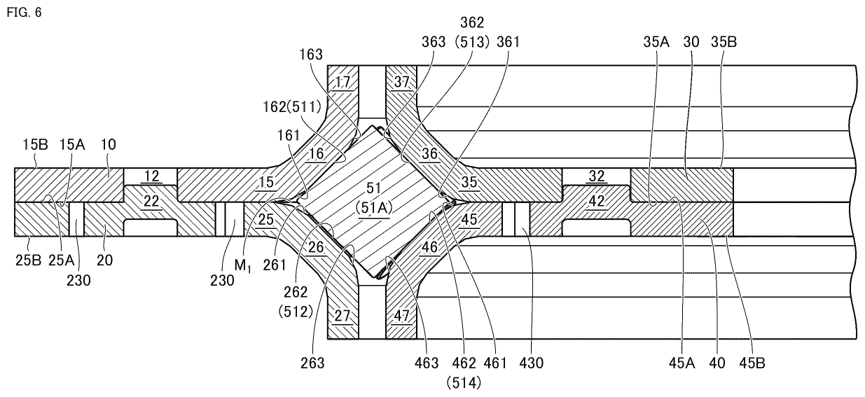

FIG. 5 is a cross-sectional view of the rolling bearing 1 taken along A-A in FIG. 1. FIG. 5 is a cross-sectional view including cross sections of first rollers 51 (FIG. 4). FIG. 6 is an enlarged cross-sectional view of the area around a first roller 51 in FIG. 5.

Referring to FIG. 1, the outer ring 1A includes an annular first outer ring 10 and an annular second outer ring 20. In Embodiment 1, the first outer ring 10 and the second outer ring 20 have the same shape. FIGS. 2A and 2B are perspective views of the first outer ring 10 seen in different angles. Referring to FIGS. 2A, 2B, and 5, the first outer ring 10 includes a first portion 15, a second portion 16, and a third portion 17. In Embodiment 1, the first portion 15, the second portion 16, and the third portion 17 have the same thickness.

The first portion 15 has a disk annular shape. The first portion 15 has a common central axis with the central axis R of the rolling bearing 1. The second portion 16 has a tubular shape. The external shape of the second portion 16 is a truncated cone shape. The second portion 16 extends from an inner edge of the first portion 15 such that its inner diameter decreases with increasing distance from the first portion 15 in the Z axis direction. The second portion 16 has an annular inner circumferential surface 16A. The inner circumferential surface 16A has a common central axis with the central axis R of the rolling bearing 1. The third portion 17 has a cylindrical shape. The third portion 17 has a common central axis with the central axis R of the rolling bearing 1. The third portion 17 is connected to an end of the second portion 16 opposite to the first portion 15 in the Z axis direction and extends along the Z axis direction.

Referring to FIGS. 5 and 6, the inner circumferential surface 16A includes an annular first surface 161 as a first region, an annular second surface 162 as a second region, and an annular third surface 163 as a third region. In Embodiment 1, the first surface 161, the second surface 162, and the third surface 163 have a common central axis with the central axis R of the rolling bearing 1. The first surface 161 connects a surface 15A of the first portion 15 on the side in contact with a fourth portion 25 to the second surface 162. In Embodiment 1, in a cross section including the central axis R, the first surface 161 has a curved shape. In the cross section including the central axis R, the second surface 162 has a flat shape. The third surface 163 connects the second surface 162 to an inner circumferential surface 17A of the third portion 17. In Embodiment 1, in the cross section including the central axis R, the third surface 163 has a curved shape.

Referring to FIGS. 2A, 2B, and 4, the first portion 15 has a plurality of (in Embodiment 1, six) mounting holes 11, penetrating in the thickness direction (direction of the central axis R), formed at equal intervals in the circumferential direction. In the first portion 15, either one of a protruding portion 13 and a through hole 12 is formed alternately between adjacent mounting holes 11, aligned in the circumferential direction. It should be noted that the rolling bearing 1 can be fixed to an external member by, for example, inserting bolts to the mounting holes 11 and screwing the bolts into screw holes in the external member.

In Embodiment 1, three protruding portions 13 are formed at equal intervals in the circumferential direction of the first portion 15. The protruding portions 13 are formed on the surface 15A of the first portion 15. The protruding portion 13 is a columnar protruding portion that protrudes from the surface 15A in the thickness direction. The protruding portion 13 is defined by a cylindrical side face 13A rising from the surface 15A and a circular end face 13C defining an end face of the cylinder. While three protruding portions 13 are formed in Embodiment 1, the number of the protruding portions is not limited thereto; it may be two to 16, for example.

Around the protruding portion 13, three slits 130 are formed. The slits 130 penetrate in the thickness direction of the first portion 15 from the surface 15A to a surface of the first portion 15. The slit 130 is an arcuate slit along a portion of the arc of an imaginary circle concentric with the protruding portion 13. The three slits 130 are provided around the protruding portion 13, at equal intervals with each other in the circumferential direction. While three slits 130 are provided around one protruding portion 13 in Embodiment 1, the number of the slits is not limited to three; two to six slits, for example, can be provided around one protruding portion 13. The slits are preferably arranged in a symmetrical manner with the protruding portion at the center. Arranging the slits so as to be symmetrical with respect to the protruding portion makes it possible to absorb misalignment between the protruding portion and the through hole regardless of the manner of misalignment (misalignment in the circumferential direction, misalignment in the radial direction, or a combination thereof).

In Embodiment 1, three through holes 12 are formed at equal intervals in the circumferential direction of the first portion 15. The through hole 12 is a through hole that penetrates in the thickness direction of the first portion 15 from the surface 15A to the surface 15B of the first portion 15. The through hole 12 is defined by a cylindrical inner circumferential wall 12A that extends to connect the surface 15A and the surface 15B. The through hole 12 has a shape corresponding to the protruding portion 13. That is, the protruding portion 13 and the through hole 12 are equal in diameter. (As used herein, being equal does not mean that the two values are mathematically identical; it includes the case where they have different diameters to the extent that they can be fitted with each other.) While three through holes 12 are formed in Embodiment 1, the number of the through holes is not limited thereto; it may be two to 16, for example.

Referring to FIGS. 1, 5, and 6, the second outer ring 20 is arranged alongside the first outer ring 10 in the Z axis direction and is fixed to the first outer ring 10. The second outer ring 20 includes a fourth portion 25, a fifth portion 26, and a sixth portion 27. In Embodiment 1, the fourth portion 25, the fifth portion 26, and the sixth portion 27 have the same thickness. In Embodiment 1, the thickness of the first outer ring 10 coincides with the thickness of the second outer ring 20. The fourth portion 25 has a disk annular shape. The surface 15A of the first outer ring 10 is opposite to and in contact with one surface 25A of the fourth portion 25 of the second outer ring 20. The fourth portion 25 has a common central axis with the central axis R of the rolling bearing 1. The fifth portion 26 has a tubular shape. The external shape of the fifth portion 26 is a truncated cone shape. The fifth portion 26 extends from an inner edge of the fourth portion 25 such that its inner diameter decreases with increasing distance from the fourth portion 25 in the Z axis direction. The fifth portion 26 extends to the opposite side of the second portion 16 in the Z axis direction. The fifth portion 26 has an inner circumferential surface 26A of an annular shape. The inner circumferential surface 26A has a common central axis with the central axis R of the rolling bearing 1. The sixth portion 27 has a cylindrical shape. The sixth portion 27 has a common central axis with the central axis R of the rolling bearing 1. The sixth portion 27 is connected to an end of the fifth portion 26 opposite to the fourth portion 25 in the Z axis direction and extends along the Z axis direction to the opposite side of the third portion 17.

The inner circumferential surface 26A includes an annular fourth surface 261, an annular fifth surface 262, and an annular sixth surface 263. The fourth surface 261, the fifth surface 262, and the sixth surface 263 have a common central axis with the central axis R of the rolling bearing 1. The fourth surface 261 connects the surface 25A of the fourth portion 25 to the fifth surface 262. In a cross section including the central axis R, the fourth surface 261 has a curved shape. In the cross section including the central axis R, the fifth surface 262 has a flat shape. The sixth surface 263 connects the fifth surface 262 to an inner circumferential surface 27A of the sixth portion 27. In the cross section including the central axis R, the sixth surface 263 has a curved shape.

Referring to FIG. 4, the fourth portion 25 of the second outer ring 20 has a plurality of (in Embodiment 1, six) mounting holes 21, penetrating in the thickness direction, formed at equal intervals in the circumferential direction. In the fourth portion either one of a protruding portion 22 and a through hole 23 is formed alternately between adjacent mounting holes 21, aligned in the circumferential direction.

In Embodiment 1, three protruding portions 22 are formed at equal intervals in the circumferential direction of the fourth portion 25. The protruding portion 22 is a columnar protruding portion that protrudes in the thickness direction from the surface 25A of the fourth portion 25. The protruding portion 22 is defined by a cylindrical side face 22A rising from the surface 25A and a circular end face 22C defining an end face of the cylinder. While three protruding portions 22 are formed in Embodiment 1, the number of the protruding portions is not limited thereto; it may be two to 16, for example.

Around the protruding portion 22, three slits 230 are formed. The slits 230 penetrate in the thickness direction of the fourth portion 45 from the surface 25A to a surface 25B of the fourth portion 25. The slit 230 is an arcuate slit along a portion of the arc of an imaginary circle concentric with the protruding portion 22. The number of the slits 230 may be changed, as in the slits 130 (FIG. 2A). The slits are preferably arranged in a symmetrical manner with the protruding portion at the center.

In Embodiment 1, the second outer ring 20 has three through holes 23 formed at equal intervals in the circumferential direction of the fourth portion 25. The through hole 23 is a through hole that penetrates in the thickness direction of the fourth portion 25 from the surface 25A to the surface 25B. The through hole 23 is defined by a cylindrical inner circumferential wall 23A that extends to connect the surface 25A and the surface 25B. The through hole 23 has a shape corresponding to the protruding portion 22. That is, the protruding portion 22 and the through hole 23 are equal in diameter. While three through holes 23 are formed in Embodiment 1, the number of the through holes is not limited thereto; it may be two to 16, for example.

Referring to FIGS. 5 and 6, the first outer ring 10 and the second outer ring 20 are opposite and fixed to each other at the surface 15A of the first portion 15 in the first outer ring 10 and the surface 25A of the fourth portion 25 in the second outer ring 20. Specifically, the through hole 12 of the first portion 15 and the protruding portion 22 of the fourth portion 25 are fitted together, and the protruding portion 13 of the first portion 15 and the through hole 23 of the fourth portion 25 are fitted together. The fitting portion between the through hole 12 and the protruding portion 22 and the fitting portion between the protruding portion 13 and the through hole 23 may each be bonded by an adhesive. Stated specifically, a layer of the adhesive may be formed between the inner circumferential walls 12A, 23A of the through holes 12, 23 and the side faces 13A, 22A of the protruding portions 13, 22.

Referring to FIG. 1, the inner ring 1B includes an annular first inner ring 30 and an annular second inner ring 40. In Embodiment 1, the first inner ring 30 and the second inner ring 40 have the same shape. FIGS. 3A and 3B are perspective views of the first inner ring 30 seen in different angles.

Referring to FIGS. 3A, 3B, 5, and 6, the first inner ring 30 includes a seventh portion 35, an eighth portion 36, and a ninth portion 37. In Embodiment 1, the seventh portion 35, the eighth portion 36, and the ninth portion 37 have the same thickness. In Embodiment 1, the thickness of the first outer ring 10 coincides with the thickness of the first inner ring 30. The seventh portion 35 has a disk annular shape. The seventh portion 35 has a common central axis with the central axis R of the rolling bearing 1. The eighth portion 36 has a tubular shape. The external shape of the eighth portion 36 is a truncated cone shape. The eighth portion 36 extends from an outer edge of the seventh portion 35 such that its outer diameter increases with increasing distance from the seventh portion 35 in the Z axis direction. The eighth portion 36 has an annular outer circumferential surface 36A. The outer circumferential surface 36A has a common central axis with the central axis R of the rolling bearing 1. The ninth portion 37 has a cylindrical shape. The ninth portion 37 has a common central axis with the central axis R of the rolling bearing 1. The ninth portion 37 is connected to an end of the eighth portion 36 opposite to the seventh portion 35 in the Z axis direction and extends along the Z axis direction.

Referring to FIGS. 5 and 6, the outer circumferential surface 36A includes an annular seventh surface 361, an annular eighth surface 362, and an annular ninth surface 363. The seventh surface 361, the eighth surface 362, and the ninth surface 363 have a common central axis with the central axis R of the rolling bearing 1. The seventh surface 361 connects a surface 35A of the seventh portion 35 on the side in contact with a tenth portion 45 to the eighth surface 362. In a cross section including the central axis R, the seventh surface 361 has a curved shape. In the cross section including the central axis R, the eighth surface 362 has a flat shape. The eighth surface 362 opposes the fifth surface 262 of the second outer ring 20. In Embodiment 1, in the cross section including the central axis R, the eighth surface 362 of the first inner ring 30 and the fifth surface 262 of the second outer ring 20 are parallel. The ninth surface 363 connects the eighth surface 362 to an outer circumferential surface 37A of the ninth portion 37. In the cross section including the central axis R, the ninth surface 363 has a curved shape.

Referring to FIGS. 3A, 3B, and 5, the seventh portion 35 has a plurality of (in the present embodiment, six) mounting holes 31, penetrating in the thickness direction (Z axis direction), formed at equal intervals in the circumferential direction. In the seventh portion 35, between adjacent mounting holes 31 in the circumferential direction, either one of a protruding portion 33 and a through hole 32 is formed alternately, aligned in the circumferential direction.

In Embodiment 1, three protruding portions 33 are formed at equal intervals in the circumferential direction of the seventh portion 35. The protruding portion 33 is a columnar protruding portion that protrudes in the thickness direction from the surface 35A of the seventh portion 35. The protruding portion 33 is defined by a cylindrical side face 33A rising from the surface 35A and a circular end face 33C defining an end face of the cylinder. While three protruding portions 33 are formed in Embodiment 1, the number of the protruding portions is not limited thereto; it may be two to 16, for example.

Around the protruding portion 33, three slits 330 are formed. The slits 330 penetrate in the thickness direction of the seventh portion 35 from the surface 35A to a surface 35B of the seventh portion 35. The slit 330 is an arcuate slit along a portion of the arc of an imaginary circle concentric with the protruding portion 33. The number of the slits 330 may be changed, as in the slits 130 (FIG. 2A). The slits are preferably arranged in a symmetrical manner with the protruding portion at the center.

In Embodiment 1, three through holes 32 are formed at equal intervals in the circumferential direction of the seventh portion 35. The through hole 32 is a through hole that penetrates in the thickness direction from the surface 35A to the surface 35B of the seventh portion 35. The through hole 32 is defined by a cylindrical inner circumferential wall 32A that extends to connect the surface 35A and the surface 35B. The through hole 32 has a shape corresponding to the protruding portion 33. That is, the through hole 32 and the protruding portion 33 are equal in diameter. While three through holes 32 are formed in Embodiment 1, the number of the through holes is not limited thereto; it may be two to 16, for example.

Referring to FIGS. 4, 5, and 6, the second inner ring 40 is arranged alongside the first inner ring 30 in the Z axis direction and is fixed to the first inner ring 30. The second inner ring 40 includes a tenth portion 45, an eleventh portion 46, and a twelfth portion 47. In Embodiment 1, the tenth portion 45, the eleventh portion 46, and the twelfth portion 47 have the same thickness. In Embodiment 1, the thickness of the second inner ring 40 coincides with the thickness of the first outer ring 10. The tenth portion 45 has a disk annular shape. The surface 35A of the first inner ring 30 is opposite to and in contact with one surface 45A of the tenth portion of the second inner ring 40. The tenth portion 45 has a common central axis with the central axis R of the rolling bearing 1. The eleventh portion 46 has a tubular shape. The external shape of the eleventh portion 46 is a truncated cone shape. The eleventh portion 46 extends from an outer edge of the tenth portion 45 such that its outer diameter increases with increasing distance from the tenth portion 45 in the Z axis direction. In the Z axis direction, the eleventh portion 46 extends to the opposite side of the eighth portion 36 of the first inner ring 30. The eleventh portion 46 has an annular outer circumferential surface 46A. The outer circumferential surface 46A has a common central axis with the central axis R of the rolling bearing 1. The twelfth portion 47 has a cylindrical shape. The twelfth portion 47 has a common central axis with the central axis R of the rolling bearing 1. The twelfth portion 47 is connected to an end of the eleventh portion 46 opposite to the tenth portion 45 in the Z axis direction and extends along the Z axis direction to the opposite side of the ninth portion 37 of the first inner ring 30.

The outer circumferential surface 46A includes an annular tenth surface 461, an annular eleventh surface 462, and an annular twelfth surface 463. The tenth surface 461, the eleventh surface 462, and the twelfth surface 463 have a common central axis with the central axis R of the rolling bearing 1. The tenth surface 461 connects the surface 45A of the tenth portion 45 on the side in contact with the seventh portion 35 to the eleventh surface 462. In a cross section including the central axis R, the tenth surface 461 has a curved shape. In the cross section including the central axis R, the eleventh surface 462 has a flat shape. The eleventh surface 462 opposes the second surface 162. In Embodiment 1, in the cross section including the central axis R, the eleventh surface 462 of the second inner ring 40 and the second surface 162 of the first outer ring 10 are parallel. In the cross section including the central axis R, a line segment connecting the second surface 162 and the eleventh surface 462 intersects (is orthogonal to) a line segment connecting the fifth surface 262 and the eighth surface 362. The twelfth surface 463 connects the eleventh surface 462 to an outer circumferential surface 47A of the twelfth portion 47. In the cross section including the central axis R, the twelfth surface 463 has a curved shape.

Referring to FIG. 4, the tenth portion 45 has a plurality of (in the present embodiment, six) mounting holes 41, penetrating in the thickness direction (Z axis direction), formed at equal intervals in the circumferential direction. In the tenth portion 45, between adjacent mounting holes 41 in the circumferential direction, either one of a protruding portion 42 and a through hole 43 is formed alternately, aligned in the circumferential direction.

In Embodiment 1, three protruding portions 42 are formed at equal intervals in the circumferential direction of the tenth portion 45. The protruding portion 42 is a columnar protruding portion that protrudes in the thickness direction from the surface 45A of the tenth portion 45. The protruding portion 42 is defined by a cylindrical side face 42A rising from the surface 45A and a circular end face 42C defining an end face of the cylinder. While three protruding portions 42 are formed in Embodiment 1, the number of the protruding portions is not limited thereto; it may be two to 16, for example.

Around the protruding portion 42, three slits 430 are formed. The slits 430 penetrate in the thickness direction of the tenth portion 45 from the surface 45A to a surface of the tenth portion 45. The slit 430 is an arcuate slit along a portion of the arc of an imaginary circle concentric with the protruding portion 42. The number of the slits 430 may be changed, as in the slits 130 (FIG. 2A). The slits are preferably arranged in a symmetrical manner with the protruding portion at the center.

In Embodiment 1, three through holes 43 are formed at equal intervals in the circumferential direction of the tenth portion 45. The through hole 43 is a through hole that penetrates in the thickness direction from the surface 45A to the surface 45B of the tenth portion 45. The through hole 43 is defined by a cylindrical inner circumferential wall 43A that extends to connect the surface 45A and the surface 45B. The through hole 43 has a shape corresponding to the protruding portion 42. That is, the through hole 43 and the protruding portion 42 are equal in diameter. While three through holes 43 are formed in Embodiment 1, the number of the through holes is not limited thereto; it may be two to 16, for example.

Referring to FIGS. 5 and 6, the first inner ring 30 and the second inner ring 40 are opposite and fixed to each other at the surface 35A of the seventh portion 35 in the first inner ring 30 and one surface 45A of the tenth portion 45 in the second inner ring 40. Specifically, the through hole 32 of the seventh portion 35 and the protruding portion 42 of the tenth portion 45 are fitted together, and the protruding portion 33 of the seventh portion 35 and the through hole 43 of the tenth portion 45 are fitted together. The fitting portion between the through hole 32 and the protruding portion 42 and the fitting portion between the protruding portion 33 and the through hole 43 may each be bonded by an adhesive. Stated more specifically, a layer of the adhesive may be formed between the inner circumferential walls 32A, 43A of the through holes 32, 43 and the side faces 33A, 42A of the protruding portions 33, 42.

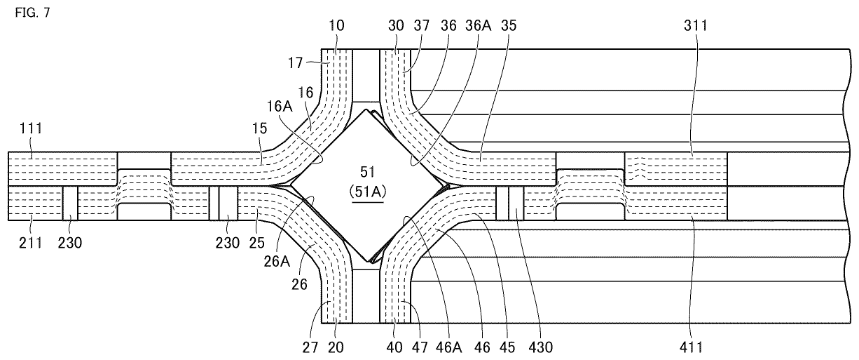

FIG. 7 is a diagram illustrating grain flows in a cross section of the rolling bearing 1 taken along A-A in FIG. 1. Referring to FIGS. 6 and 7, in the first outer ring 10, grain flows 111 in the steel that constitutes the first outer ring 10 extend along the surface 15A of the first portion 15, the inner circumferential surface 16A of the second portion 16, and the inner circumferential surface 17A of the third portion 17. The grain flows 111 extend along the first surface 161, the second surface 162, and the third surface 163 of the inner circumferential surface 16A. In Embodiment 1, the grain flows 111 extend parallel to the second surface 162. Similarly, in the second outer ring 20, grain flows 211 in the steel that constitutes the second outer ring 20 extend along the surface 25A of the fourth portion 25, the inner circumferential surface 26A of the fifth portion 26, and the inner circumferential surface 27A of the sixth portion 27. The grain flows 211 extend along the fourth surface 261, the fifth surface 262, and the sixth surface 263 of the inner circumferential surface 26A. In Embodiment 1, the grain flows 211 extend parallel to the fifth surface 262. Also similarly, in the first inner ring 30, grain flows 311 in the steel that constitutes the first inner ring 30 extend along the surface 35A of the seventh portion 35, the outer circumferential surface 36A of the eighth portion 36, and the outer circumferential surface 37A of the ninth portion 37. The grain flows 311 extend along the seventh surface 361, the eighth surface 362, and the ninth surface 363 of the outer circumferential surface 36A. In Embodiment 1, the grain flows 311 extend parallel to the eighth surface 362. Also similarly, in the second inner ring 40, grain flows 411 in the steel that constitutes the second inner ring 40 extend along the surface 45A of the tenth portion 45, the outer circumferential surface 46A of the eleventh portion 46, and the outer circumferential surface 47A of the twelfth portion 47. The grain flows 411 extend along the tenth surface 461, the eleventh surface 462, and the twelfth surface 463 of the outer circumferential surface 46A. In the present embodiment, the grain flows 411 extend parallel to the eleventh surface 462.

The grain flows 111, 211, 311, and 411 are formed continuously along the third surface 163, the sixth surface 263, the ninth surface 363, and the twelfth surface 463, respectively. Adopting such a configuration can suppress the reduction in rigidity of the first outer ring 10, the second outer ring 20, the first inner ring 30, and the second inner ring when attaching the first outer ring 10, the second outer ring 20, the first inner ring 30, and the second inner ring 40 to another member.

Referring to FIG. 4, the plurality of rollers 1C include a plurality of first rollers 51 and a plurality of second rollers 52. In Embodiment 1, the first rollers 51 and the second rollers 52 are made of steel. In the present embodiment, the first rollers 51 and the second rollers 52 are made of, for example, SUJ2 as specified in the JIS standard. In Embodiment 1, the rollers 1C include 27 first rollers 51 and 27 second rollers 52. The first rollers 51 and the second rollers 52 have a cylindrical shape. Each first roller 51 has a cylindrical outer circumferential surface 51A and circular end faces 51B and 51C at respective ends of the outer circumferential surface 51A. Each second roller 52 has a cylindrical outer circumferential surface 52A and circular end faces 52B and 52C at respective ends of the outer circumferential surface 52A. The first rollers 51 and the second rollers 52 are arranged alternately in the circumferential direction.

Referring to FIG. 6, the first rollers 51 are disposed to be able to roll while contacting, at their outer circumferential surfaces 51A, the second surface 162 in the annular-shaped inner circumferential surface 16A of the second portion 16 of the first outer ring 10. The second surface 162 of the first outer ring 10 constitutes a first rolling surface 511. Further, the first rollers 51 are disposed to be able to roll while contacting the eleventh surface 462 in the annular-shaped outer circumferential surface 46A of the eleventh portion 46 of the second inner ring 40 at their outer circumferential surfaces 51A. The eleventh surface 462 of the second inner ring constitutes a fourth rolling surface 514. The first rolling surface 511 and the fourth rolling surface 514 have a common central axis with the central axis R of the rolling bearing 1. One end face 51B in the axial direction of a first roller 51 is opposite to the eighth surface 362 of the first inner ring 30. The other end face 51C in the axial direction of the first roller 51 is in contact with the fifth surface 262 of the second outer ring. In the present embodiment, an annular space M₁ is formed enclosed by the first surface 161, the fourth surface 261, and the first roller 51.

Further, referring to FIGS. 6 and 7, the steel grain flows 111, 211, 311, and 411 are formed continuously along the first surface 161, the fourth surface 261, the seventh surface 361, and the tenth surface 461. Adopting such a configuration can enhance the flexural strength of the first outer ring 10, the second outer ring 20, the first inner ring 30, and the second inner ring 40 when the first rolling surface 511, a second rolling surface 512, a third rolling surface 513, and the fourth rolling surface 514 are subjected to loads applied from the first rollers 51 and the second rollers 52.

In the rolling bearing 1 in Embodiment 1, in a cross section including the central axis R, the grain flows of the steels constituting the first outer ring 10, the second outer ring the first inner ring 30, and the second inner ring 40 extend along the first rolling surface 511, the second rolling surface 512, the third rolling surface 513, and the fourth rolling surface 514, respectively. That is, the grain flows in each of the first rolling surface 511, the second rolling surface 512, the third rolling surface 513, and the fourth rolling surface 514 are formed continuously without a break. As a result, the contact of the first rollers 51 and the second rollers 52 with the ends of the steel grain flows can be suppressed. This configuration can enhance the durability of the inner ring 1B and the outer ring 1A. As such, the rolling bearing 1 in Embodiment 1 has improved durability.

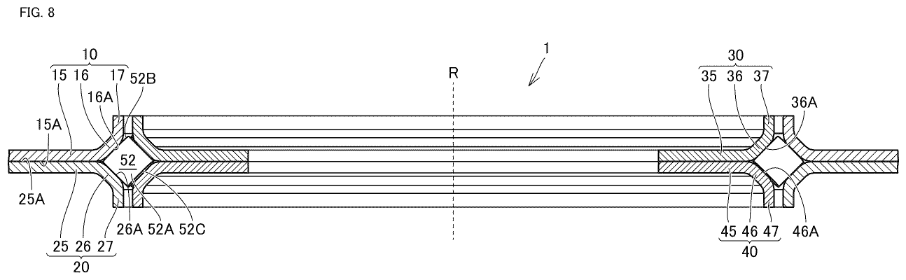

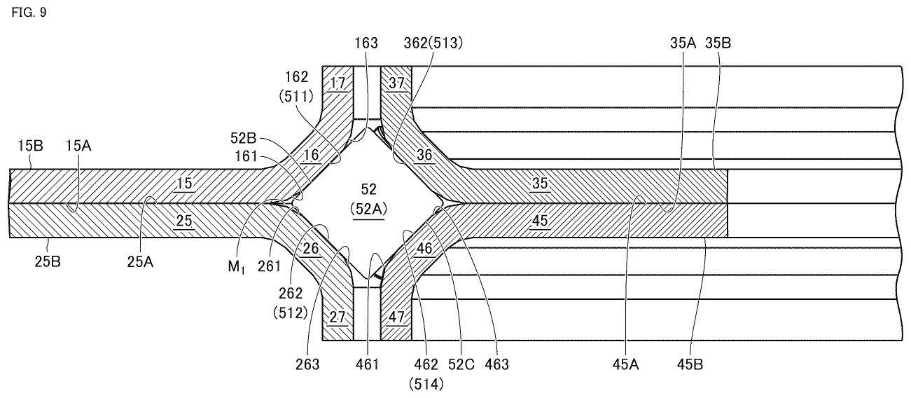

FIG. 8 is a cross-sectional view of the rolling bearing 1 taken along B-B in FIG. 1. FIG. 8 is a cross section including the cross sections of second rollers 52. FIG. 9 is an enlarged cross-sectional view of the area around a second roller in FIG. 8. Referring to FIGS. 8 and 9, the second rollers 52 are disposed to be able to roll while contacting, at their outer circumferential surfaces 52A, the fifth surface 262 of the second outer ring 20 and the eighth surface 362 of the first inner ring 30. The fifth surface 262 of the second outer ring 20 constitutes the second rolling surface 512. The eighth surface 362 of the first inner ring 30 constitutes the third rolling surface 513. The second rolling surface 512 and the third rolling surface 513 have a common central axis with the central axis R of the rolling bearing 1. One end face 52B in the axial direction of a second roller 52 is in contact with the second surface 162 of the first outer ring 10. The other end face 52C in the axial direction of the second roller 52 is opposite to the eleventh surface 462 of the second inner ring 40. In Embodiment 1, the annular space M₁ is formed enclosed by the first surface 161, the fourth surface 261, and the second roller 52 (FIG. 9). Referring to FIGS. 6 and 9, the first roller 51 has a central axis that intersects (is orthogonal to) a central axis of the second roller 52. Here, the state in which the central axis of the first roller 51 intersects the central axis of the second roller 52 means that when the center of gravity of the first roller 51 and the second roller 52 passes through a predetermined point during rotation of the rolling bearing 1, the central axis of the first roller 51 and the central axis of the second roller 52 intersect (orthogonally) with each other. The first rolling surface 511, the second rolling surface 512, the third rolling surface 513, and the fourth rolling surface 514 define a ring-shaped load-carrying race of the rolling bearing 1 through which the first rollers 51 and the second rollers 52 are able to roll.

A description will now be made of a method for producing the rolling bearing 1 in Embodiment 1. First, a first steel plate, a second steel plate, a third steel plate, and a fourth steel plate having a flat plate shape are prepared. Next, the first steel plate, the second steel plate, the third steel plate, and the fourth steel plate are each subjected to press working. In this manner, the first outer ring 10, the second outer ring 20, the first inner ring 30, and the second inner ring 40 having the shapes shown in FIGS. 2A, 2B, and 3A, 3B are formed. During the press working, the first steel plate is bent to form the portions 15, 16, and 17 in the first outer ring 10. Further, the through holes 12, the protruding portions 13, the slits 130, and the like are also formed. The same applies to the second outer ring 20, the first inner ring 30, and the second inner ring 40.

Next, referring to FIG. 5, the inner circumferential surface 16A of the second portion 16, the inner circumferential surface 26A of the fifth portion 26, the outer circumferential surface 36A of the eighth portion 36, and the outer circumferential surface 46A of the eleventh portion 46 are subjected to known heat treatment. More specifically, carburizing or carbonitriding treatment, and quenching and tempering and the like are performed. Performing the heat treatment can improve the hardness of the inner circumferential surfaces 16A and 26A and the outer circumferential surfaces 36A and 46A. In Embodiment 1, no grinding work is performed on the inner circumferential surfaces 16A and 26A and the outer circumferential surfaces 36A and 46A. Next, the second inner ring is attached to the first inner ring 30 to form the inner ring 1B. More specifically, the protruding portions 33 are fitted into the through holes 43 and the protruding portions 42 are fitted into the through holes 32. At this time, an adhesive may be applied to the fitting portion between the protruding portion 33 and the through hole 43, the fitting portion between the protruding portion 42 and the through hole 32, and around these fitting portions, for bonding the fitting portions and surfaces around them. If the protruding portions 33, 42 and the through holes 32, 43 are formed accurately in place, the protruding portions and the through holes are fitted together without producing significant stress. On the other hand, if there are misalignments between the protruding portions 33, 42 and the through holes 32, 43, large stresses are generated when fitting them. The slits 330 and 430 formed around the protruding portions 33 and 42 are less rigid than the main regions of the first inner ring 30 and the second inner ring 40, so deformation occurs at the positions of the slits 330 and 430. This absorbs the misalignments between the protruding portions 33, 42 and the through holes 32, 43. The inner ring 1B thus formed and the second outer ring 20 are attached to a jig. At this time, they are attached such that the outer circumferential surface 47A of the twelfth portion 47 and the inner circumferential surface 27A of the sixth portion 27 oppose each other (see FIG. 5). Next, the first rollers 51 and the second rollers 52 are disposed alternately in the space enclosed by the inner ring 1B and the second outer ring 20. Next, the first outer ring 10 is attached to the second outer ring to form the outer ring 1A. More specifically, the protruding portions 13 are fitted into the through holes 23 and the protruding portions 22 are fitted into the through holes 12. At this time, an adhesive may be applied to the fitting portions between the protruding portions 13, 22 and the through holes 12, 23, and around these fitting portions, for bonding the fitting portions and surfaces around them. If the protruding portions 13, 22 and the through holes 12, 23 are formed accurately in place, the protruding portions and the through holes are fitted together without producing significant stress. On the other hand, if there are misalignments between the protruding portions 13, 22 and the through holes 12, 23, deformation occurs at the positions of the slits 130 and 230. This absorbs the misalignments between the protruding portions 13, 22 and the through holes 12, 23. Therefore, compared to the case where no slits are provided, the decrease in durability due to the decrease in accuracy of roundness and the like can be suppressed.

For the adhesive for bonding the first outer ring 10 with the second outer ring 20 and the first inner ring 30 with the second inner ring 40, a known adhesive can be used. Examples of the adhesive available include, but are not limited to, anaerobic adhesives, and epoxy adhesive and other resin-based adhesives.

### (Variation 1)

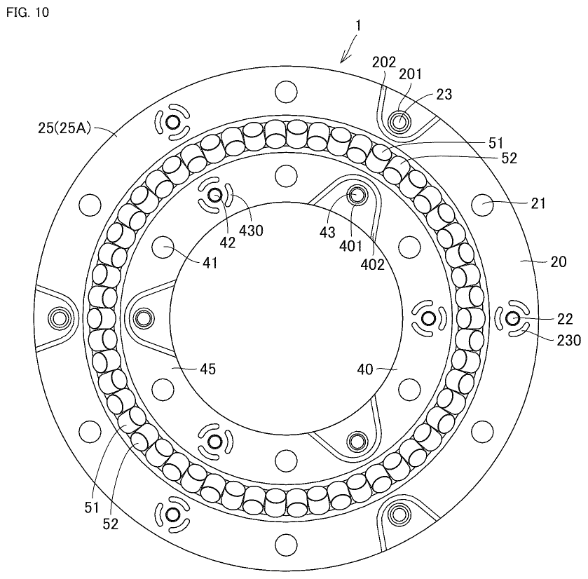

A description will now be made of a variation of the rolling bearing 1 in Embodiment 1. FIG. 10 shows a variation of the rolling bearing 1 of Embodiment 1. The rolling bearing 1 is shown with the first outer ring 10 and the first inner ring 30 removed. In the variation in FIG. 10, on the surface 25A of the second outer ring 20, a ring-shaped recess 201 is formed around the through hole 23 to surround the through hole 23. Further, on the surface 25A, a groove 202 is formed between the through hole 23 and the rolling surface (second rolling surface 512, FIG. 6) in the second outer ring 20, the groove surrounding the through hole 23 and having its both ends opening to the outer circumference side of the second outer ring 20. That is, the groove 202 demarcates the through hole 23 from the second rolling surface 512. With the provision of the recess 201 and the groove 202, in the case of bonding the fitting portion between the through hole 23 and the protruding portion 13 (FIG. 1), the bonding area can be increased. Further, even if an excessive amount of adhesive is applied, the adhesive is discharged without penetrating to the rolling surfaces.

### (Variation 2)

While the recess provided around the through hole is a ring-shaped recess in Variation 1, the shape of the recess is not limited thereto. By way of example, the shape of the recess may be multiple rings, or a plurality of linear grooves extending in one direction parallel to each other. The shape of the recess may be a lattice-shaped groove in which a plurality of linear grooves intersect each other, or wedge-shaped grooves may be arranged aligned in the circumferential direction around the through hole. The recess may be in the form of a plurality of dot-shaped recesses dispersedly arranged, or a combination of an annular groove and radially extending linear grooves. Further, the surface around the through hole may be roughened. By providing a recess or roughened surface around the through hole, the bonding area can be increased and the adhesion strength can be further improved. In addition, the recess or roughened surface can hold the adhesive and prevent the adhesive from spreading to unintended portions.

### (Variation 3)

While the slits are formed around the protruding portion in Embodiment 1, the slits may be formed around the through hole in place of, or in addition to, around the protruding portion. The slits may be formed around the through hole, and the above-described recess or groove may be formed around the protruding portion.

### (Variation 4)

While the case of adopting the first and second rollers 51 and 52 made of steel as the rolling elements has been described in Embodiment 1, not limited to this, first and second rollers 51 and 52 made of ceramic (e.g., alumina or silicon nitride) or resin may also be adopted. Adopting such rollers as described above achieves a weight reduction of the rolling bearing 1. Further, while the first and second rollers 51 and 52 are arranged adjacent to each other in Embodiment 1, a separator can be disposed between the first and second rollers.

### Embodiment 2

A description will now be made of Embodiment 2 of the rolling bearing according to the present disclosure. The rolling bearing 1 in Embodiment 2 basically has a similar structure and exerts similar effects as the rolling bearing in Embodiment 1. However, Embodiment 2 differs from Embodiment 1 in that the outer ring 1A and the inner ring 1B are formed flat, that the rolling elements are balls, and that slits and pin holes are formed. The points that are different from the case of Embodiment 1 will mainly be described below.

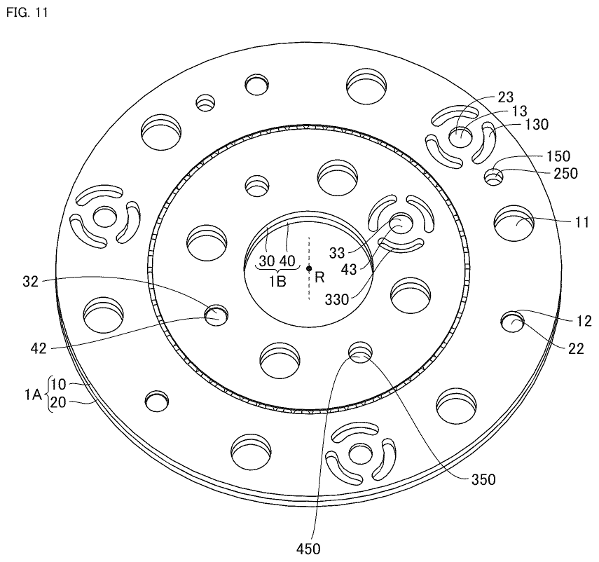

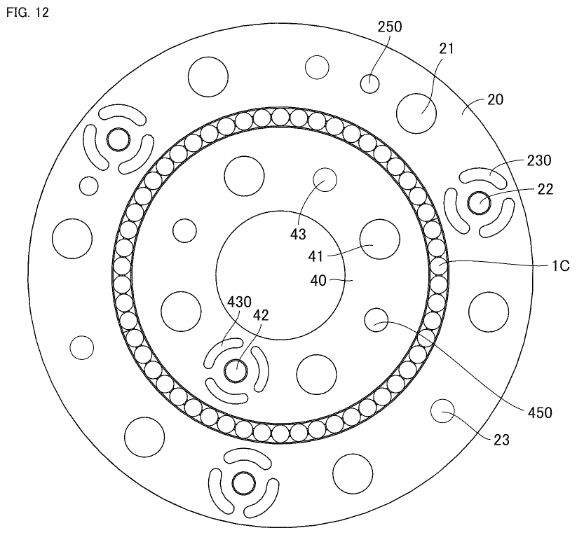

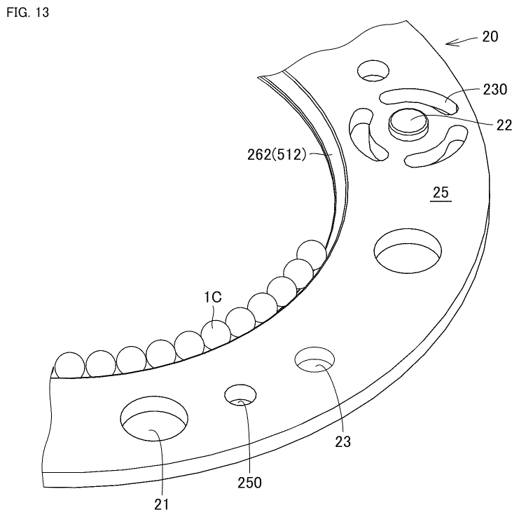

FIG. 11 is a perspective view of a rolling bearing 1 in Embodiment 2. FIG. 12 is a perspective view of the rolling bearing 1 in Embodiment 2, with the first outer ring 10 and the first inner ring 30 removed therefrom. FIG. 13 is an enlarged perspective view of a portion of the second outer ring 20 and rolling elements 1C in Embodiment 2, with the rolling elements 1C partially removed therefrom.

Referring to FIG. 11, the outer ring 1A in Embodiment 2 is formed flat, with no portions protruding in the central axis R direction. The through holes 12 of the first outer ring 10 and the protruding portions 22 of the second outer ring 20 are fitted together, and the protruding portions 13 of the first outer ring 10 and the through holes 23 of the second outer ring 20 are fitted together. These fitting portions are bonded. Further, around the protruding portions 13, slits 130 are formed penetrating in the thickness direction of the first outer ring 10. The slit 130 is an arcuate slit along a portion of the arc of an imaginary circle concentric with the protruding portion 13. Three slits 130 are arranged around a protruding portion 13.

The inner ring 1B in Embodiment 2 is formed flat, with no portions protruding in the central axis R direction. The through holes 32 of the first inner ring 30 and the protruding portions 42 of the second inner ring 40 are fitted together, and the protruding portions 33 of the first inner ring 30 and the through holes 43 of the second inner ring 40 are fitted together. These fitting portions are bonded. Further, around the protruding portions 33, slits 330 are formed penetrating in the thickness direction of the first inner ring 30. The slit 330 is an arcuate slit along a portion of the arc of an imaginary circle concentric with the protruding portion 33. Three slits 330 are arranged around a protruding portion 33. Referring to FIGS. 11 and 12, the second outer ring 20 and the first outer ring 10 have the same shape, and the second inner ring 40 and the first inner ring 30 have the same shape, so common descriptions are not repeated.

In Embodiment 2, in addition to the mounting holes 11, 21, 31, and 41, small through holes 150, 250, 350, and 450 are formed penetrating in the thickness direction. The small through holes 150, 250, 350, and 450 can receive pins (not shown) for use in positioning when attaching the rolling bearing 1 to a counter member. Since the outer ring 1A and the inner ring 1B of Embodiment 2 are flat, protruding portions of the outer ring 1A and the inner ring 1B cannot be used as a reference for positioning. Therefore, the small through holes 150 and 250 are provided in the outer ring 1A, and the positioning pins are inserted into the small through holes 150 and 250, whereby positioning can be done. Further, the small through holes 350 and 450 are provided in the inner ring 1B, and the positioning pins are inserted into the small through holes 350 and 450, whereby positioning can be done. According to such a configuration, a rolling bearing 1 that is thinner without protruding portions and capable of secure positioning is obtained.

It should be understood that the embodiments disclosed herein are illustrative and non-restrictive in every respect. The scope of the present invention is defined by the terms of the claims, rather than the description above, and is intended to include any modifications within the scope and meaning equivalent to the terms of the claims.

### REFERENCE SIGNS LIST

1: rolling bearing; 1A: outer ring; 1B: inner ring; 1C: roller; 10: first outer ring; 11, 21, 31, 41: mounting hole; 12, 23, 32, 43: through hole; 13, 22, 33, 42: protruding portion; 15: first portion; 15A, 25A, 35A, 45A: surface; 16: second portion; 16A, 17A, 26A, 27A, 36A, 46A: inner circumferential surface; 16B, 36A, 37A, 46A, 47A, 51A, 52A: outer circumferential surface; 17: third portion; 51B, 51C, 52B, 52C: end face; 20: second outer ring; 25: fourth portion; 26: fifth portion; 27: sixth portion; 30: first inner ring; 35: seventh portion; 36: eighth portion; 37: ninth portion; 40: second inner ring; 45: tenth portion; 46: eleventh portion; 47: twelfth portion; 51: first roller; 52: second roller; 101, 201, 301, 401: recess; 102, 202, 302, 402: groove, 130, 230, 330, 430: slit; 111, 211, 311, 411: grain flow; 150, 250, 350, 450: small through hole; 161: first surface; 162: second surface; 163: third surface; 261: fourth surface; 262: fifth surface; 263: sixth surface; 361: seventh surface; 362: eighth surface; 363: ninth surface; 461: tenth surface; 462: eleventh surface; 463: twelfth surface; 511: first rolling surface; 512: second rolling surface; 513: third rolling surface; and 514: fourth rolling surface.

1. A rolling bearing comprising:
an outer ring made of steel;
an inner ring made of steel, having a common central axis with the outer ring and arranged on an inner circumference side of the outer ring; and
a plurality of rolling elements disposed to be able to roll on an inner circumferential surface of the outer ring and an outer circumferential surface of the inner ring;
the outer ring including
a first outer ring and a second outer ring arranged alongside the first outer ring in a first axis direction in which the central axis extends, the second outer ring being fixed to the first outer ring,
the inner ring including
a first inner ring and a second inner ring arranged alongside the first inner ring in the first axis direction, the second inner ring being fixed to the first inner ring,
the outer ring having a protruding portion and a through hole corresponding to the protruding portion formed in one and the other of opposing portions in the first and second outer rings, the protruding portion and the through hole being fitted together,
the inner ring having a protruding portion and a through hole corresponding to the protruding portion formed in one and the other of opposing portions in the first and second inner rings, the protruding portion and the through hole being fitted together,
a slit being provided around either one or both of the protruding portion and the through hole.

2. The rolling bearing according to claim 1, wherein a plurality of said slits are provided around the protruding portion or the through hole.

3. The rolling bearing according to claim 1, wherein the slit is provided around the protruding portion.

4. The rolling bearing according to claim 1, wherein a fitting portion between the protruding portion and the through hole is bonded.

5. The rolling bearing according to claim 1, wherein
the first outer ring has an annular first rolling surface constituting the inner circumferential surface of the outer ring,
the second outer ring has an annular second rolling surface constituting the inner circumferential surface of the outer ring,
the first inner ring has an annular third rolling surface constituting the outer circumferential surface of the inner ring and opposing the second rolling surface,
the second inner ring has an annular fourth rolling surface constituting the outer circumferential surface of the inner ring and opposing the first rolling surface, a line segment connecting the fourth rolling surface and the first rolling surface intersecting a line segment connecting the second rolling surface and the third rolling surface in a cross section including the central axis of the first rolling surface, and
in a cross section including the central axis, grain flows in the steel constituting the first outer ring extend along the first rolling surface, grain flows in the steel constituting the second outer ring extend along the second rolling surface, grain flows in the steel constituting the first inner ring extend along the third rolling surface, and grain flows in the steel constituting the second inner ring extend along the fourth rolling surface.
